(19) United States
(12) Patent Application Publication
(10) Pub. No.: US 2025/0048471 A1
(43) Pub. Date: Feb. 6, 2025

(54) BEAM INDICATION METHOD, USER EQUIPMENT AND BASE STATION

(71) Applicant: Huizhou TCL Cloud Internet Corporation Technology Co., Ltd., Huizhou, Guangdong (CN)

(72) Inventors: Kai LIU, Huizhou, Guangdong (CN); Jia SHENG, Huizhou, Guangdong (CN)

(73) Assignee: Huizhou TCL Cloud Internet Corporation Technology Co., Ltd., Huizhou, Guangdong (CN)

(21) Appl. No.: 18/727,328

(22) PCT Filed: Sep. 14, 2021
(86) PCT No.: PCT/CN2021/118360

§ 371 Date: Jul. 8, 2024

(51) Int. Cl. H04W 76/20; H04L 5/00; H04W 16/28; H04W 52/24; H04W 72/231

(52) U.S. Cl. CPC H04W 76/20; H04L 5/0051; H04W 16/28; H04W 52/242; H04W 72/231

(57) ABSTRACT

As a solution of unified transmission configuration indication (TCI) framework, a beam indication method, a user equipment and a base station are provided. The unified TCI state framework contains joint downlink (DL)/uplink (UL) TCI state and separate DL/UL TCI state, which share a common TCI state pool. Radio resource control (RRC) signalling of unified TCI state, media access control (MAC) control element (CE) used for unified TCI state activation/deactivation and downlink control information (DCI) applied for DL beam indication support the unified TCI state framework. Introducing procedure of the joint DL/UL TCI state and the separate DL/UL TCI state reduces signalling overhead and leads to more flexible and uniform DL/UL beam indication.

### TECHNICAL FIELD

The present application relates to wireless communication, and more particularly, to a beam indication method, a user equipment (UE) and a base station (BS).

### BACKGROUND ART

The fifth-generation (5G) standard developed by the Third Generation Partnership Project (3GPP) supports a multitude of different services each with very different requirements. These services include Enhanced Mobile Broadband (eMBB) for high data rate transmission, Ultra-Reliable Low Latency Communication (URLLC) for devices requiring low latency and high link reliability and Massive Machine-Type Communication (mMTC) to support a large number of low-power devices for a long life-time requiring highly energy efficient communication.

Multiple-input multiple-output (MIMO) is an effective approach to enhance the capacity of a radio link due to the multiplexing of both transmit and receive antennas. MIMO refers to a practical technique for sending and receiving more than one data signal simultaneously over the same radio channel, which improves the performance of spectral efficiency greatly. Multi-beam operation is currently based on beam management enhancement.

The target of beam management enhancement is mainly for latency and overhead reduction, the beam management typically includes three produces, i.e., beam measurement, beam reporting, and beam indication. Firstly, it is expected that a base station (e.g., gNodeB) sweeps multiple candidate beams for further management and transmits these beams to a user equipment (UE), and the UE measures the beams based on some performance criteria. Then, after beam measurement, the UE reports the beams which satisfy the performance criteria to gNodeB for further implementation. Finally, the gNodeB selects the best beam to indicate the transmission of physical downlink shared channel (PDSCH).

The beam indication technique is shown in FIG. 1. The beam link between gNodeB and UE should be established to enhance the beam indication. The dynamic beam indication of PDSCH has been designed to reduce the latency and overhead. The dynamic beam indication is based on transmission configuration indication (TCI) states which associate with the downlink reference signals (DL-RS), i.e., SS block (SSB) and channel-state information reference signal (CSI-RS). The beam indication for PDSCH is dynamically triggered by downlink control information (DCI) carrying on physical downlink control channel (PDCCH). UE applies the indicated beam and switches to a corresponding Rx beam after successfully decoding DCI format.

In existing arts, each downlink (DL) channel is configured with different TCI state list by RRC signalling. For PDSCH reception, gNodeB configures a TCI state list which associates with multiple candidate TCI states within the higher layer parameter PDSCH-Config. For PDCCH reception, gNodeB configures the other TCI state list within the higher layer parameter PDCCH-Config. Different medium access control (MAC) control element (CE)/DCI is used to indicate/activate TCI state for each DL channel dependently. For PDSCH reception, gNodeB activates the candidate TCI states by MAC CE to map the candidate TCI states to the codepoints of the DCI field, and then indicates one TCI state for the deModulation reference signal (DMRS) port of PDSCH by DCI. For PDCCH reception, gNodeB indicates one TCI state by MAC CE for the DMRS antenna port of PDCCH in the control resource set (CORESET).

In existing arts, like DL channel, each uplink (UL) channel is configured with different spatial assumption by Radio Resource Control (RRC) signalling. For physical uplink control channel (PUCCH) transmission, gNodeB configures a spatial setting provided by PUCCH-SpatialRelationInfo which contains multiple candidate spatial relations within the higher layer parameter PUCCH-Config. And gNodeB indicates one spatial relation by MAC CE for a PUCCH resource at a time. For physical uplink shared channel (PUSCH) transmission, the UE indirectly derived the spatial relation info either from PUCCH (PUSCH scheduled with DCI format 0_0) or sounding reference signal (SRS) resource(s).

Obviously, the DL TCI state and UL spatial relation configuration and indication mechanisms are designed separately in existing arts. Some problems may exist such as latency and signalling overhead because many groups of RRC and MAC CE signalling is needed to configure and indicate beams for different DL and UL channels. To solve the problems, unified TCI framework as one of the key components of multi-beam objectives is proposed. However, the unified TCI framework needs to be further developed in many aspects and needs further improvements.

### SUMMARY

The objective of the present application is to provide a beam indication method, a user equipment (UE) and a base station for enhancing the unified TCI framework.

In a first aspect, an embodiment of the present application provides a user equipment (UE), including a processor, configured to call and run program instructions stored in a memory, to execute:
being configured by radio resource control (RRC) signalling with one or multiple transmission configuration indication (TCI) states forming a common TCI state pool;
being indicated by medium access control (MAC) control element (CE) for downlink (DL) channel TCI states activation which TCI states in the common TCI state pool are active;
being indicated by DL downlink control information (DCI) which TCI state in the activate TCI states is applied for DL beam indication;
in a case of the one or multiple TCI states being joint DL/uplink (UL) TCI state, carrying out UL Tx spatial relation based on the TCI state which is indicated by the DL DCI; and
in a case of the one or multiple TCI states being separate DL/UL TCI state, being indicated by MAC CE for UL channel TCI states activation which TCI states in the common TCI state pool are active, and being indicated by UL DCI which TCI state in the activate TCI states activated by the MAC CE for UL channel TCI states activation is applied for the UL Tx spatial relation.

In a second aspect, an embodiment of the present application provides a base station (BS), including a processor, configured to call and run program instructions stored in a memory, to execute:
configuring a user equipment (UE) by radio resource control (RRC) signalling with one or multiple transmission configuration indication (TCI) states forming a common TCI state pool;
indicating to the UE by medium access control (MAC) control element (CE) for downlink (DL) channel TCI states activation which TCI states in the common TCI state pool are active;
indicating to the UE by DL downlink control information (DCI) which TCI state in the activate TCI states is applied for DL beam indication;
in a case of the one or multiple TCI states being joint DL/uplink (UL) TCI state, carrying out UL Tx spatial relation based on the TCI state which is indicated by the DL DCI; and
in a case of the one or multiple TCI states being separate DL/UL TCI state, indicating to the UE by MAC CE for UL channel TCI states activation which TCI states in the common TCI state pool are active, and indicating to the UE by UL DCI which TCI state in the activate TCI states activated by the MAC CE for UL channel TCI states activation is applied for the UL Tx spatial relation.

In a third aspect, an embodiment of the present application provides a beam indication method, performed by a user equipment (UE), the method including:
being configured by radio resource control (RRC) signalling with one or multiple transmission configuration indication (TCI) states forming a common TCI state pool;
being indicated by medium access control (MAC) control element (CE) for downlink (DL) channel TCI states activation which TCI states in the common TCI state pool are active;
being indicated by DL downlink control information (DCI) which TCI state in the activate TCI states is applied for DL beam indication;
in a case of the one or multiple TCI states being joint DL/uplink (UL) TCI state, carrying out UL Tx spatial relation based on the TCI state which is indicated by the DL DCI; and
in a case of the one or multiple TCI states being separate DL/UL TCI state, being indicated by MAC CE for UL channel TCI states activation which TCI states in the common TCI state pool are active, and being indicated by UL DCI which TCI state in the activate TCI states activated by the MAC CE for UL channel TCI states activation is applied for the UL Tx spatial relation.

In a fourth aspect, an embodiment of the present application provides a beam indication method, performed by a base station (BS), the method including:
configuring a user equipment (UE) by radio resource control (RRC) signalling with one or multiple transmission configuration indication (TCI) states forming a common TCI state pool;
indicating to the UE by medium access control (MAC) control element (CE) for downlink (DL) channel TCI states activation which TCI states in the common TCI state pool are active;
indicating to the UE by DL downlink control information (DCI) which TCI state in the activate TCI states is applied for DL beam indication;
in a case of the one or multiple TCI states being joint DL/uplink (UL) TCI state, carrying out UL Tx spatial relation based on the TCI state which is indicated by the DL DCI; and
in a case of the one or multiple TCI states being separate DL/UL TCI state, indicating to the UE by MAC CE for UL channel TCI states activation which TCI states in the common TCI state pool are active, and indicating to the UE by UL DCI which TCI state in the activate TCI states activated by the MAC CE for UL channel TCI states activation is applied for the UL Tx spatial relation.

In a fifth aspect, an embodiment of the present application provides a user equipment (UE), comprising a processor, configured to call and run program instructions stored in a memory, to execute:
being configured by RRC signalling with one or multiple path loss reference signals forming a common path loss reference signal pool; and
being indicated by different medium access control (MAC) control element (CE) which path loss reference signals in the common path loss reference signal pool are applied for power control of physical uplink control channel (PUCCH), physical uplink shared channel (PUSCH) and sounding reference signal (SRS), respectively.

In a sixth aspect, an embodiment of the present application provides a base station (BS), comprising a processor, configured to call and run program instructions stored in a memory, to execute:
configuring a user equipment (UE) by RRC signalling with one or multiple path loss reference signals forming a common path loss reference signal pool; and
indicating to the UE by different medium access control (MAC) control element (CE) which path loss reference signals in the common path loss reference signal pool are applied for power control of physical uplink control channel (PUCCH), physical uplink shared channel (PUSCH) and sounding reference signal (SRS), respectively.

In a seventh aspect, an embodiment of the present application provides a method, performed by a user equipment (UE), the method comprising:
being configured by RRC signalling with one or multiple path loss reference signals forming a common path loss reference signal pool; and
being indicated by different medium access control (MAC) control element (CE) which path loss reference signals in the common path loss reference signal pool are applied for power control of physical uplink control channel (PUCCH), physical uplink shared channel (PUSCH) and sounding reference signal (SRS), respectively.

In an eighth aspect, an embodiment of the present application provides a method, performed by a base station (BS), the method comprising:
configuring a user equipment (UE) by RRC signalling with one or multiple path loss reference signals forming a common path loss reference signal pool; and
indicating to the UE by different medium access control (MAC) control element (CE) which path loss reference signals in the common path loss reference signal pool are applied for power control of physical uplink control channel (PUCCH), physical uplink shared channel (PUSCH) and sounding reference signal (SRS), respectively.

In a ninth aspect, an embodiment of the present application provides a computer readable storage medium provided for storing a computer program, which enables a computer to execute the method of any of the third aspect to the fourth aspect.

In a tenth aspect, an embodiment of the present application provides a computer program product, which includes computer program instructions enabling a computer to execute the method of any of the third aspect to the fourth aspect.

In a eleventh aspect, an embodiment of the present application provides a computer program, when running on a computer, enabling the computer to execute the method of any of the third aspect to the fourth aspect.

### DESCRIPTION OF DRAWINGS

In order to more clearly illustrate the embodiments of the present application or related art, the following figures that will be described in the embodiments are briefly introduced. It is obvious that the drawings are merely some embodiments of the present application, a person having ordinary skill in this field can obtain other figures according to these figures without paying the premise.

FIG. 1 is a schematic diagram illustrating beam indication in multi-beam transmission.

FIG. 2 is a block diagram illustrating one or more user equipments (UEs) and a base station in a communication network system according to an embodiment of the present application.

FIG. 3 is a flowchart of a beam indication method according to an embodiment of the present application.

FIG. 4 is a schematic diagram illustrating the procedure of joint DL/UL TCI state application according to an embodiment of the present application.

FIG. 5 is a schematic diagram illustrating the procedure of separate DL/UL TCI state application according to an embodiment of the present application.

FIG. 6 is a schematic diagram illustrating an example of unified TCI states activation/deactivation for DL channels MAC CE according to an embodiment of the present application.

FIG. 7 is a schematic diagram illustrating an example of unified TCI states activation/deactivation for UL channels MAC CE according to an embodiment of the present application.

FIG. 8 is a flowchart of a path loss reference signal indication method according to an embodiment of the present application.

FIG. 9 is a schematic diagram illustrating the procedure of unified path loss reference signal application according to an embodiment of the present application.

FIG. 10A is a schematic diagram illustrating an example of MAC CE used for path loss reference signal indication for PUCCH according to an embodiment of the present application.

FIG. 10B is a schematic diagram illustrating an example of MAC CE used for path loss reference signal indication for PUSCH according to an embodiment of the present application.

FIG. 10C is a schematic diagram illustrating an example of MAC CE used for path loss reference signal indication for SRS according to an embodiment of the present application.

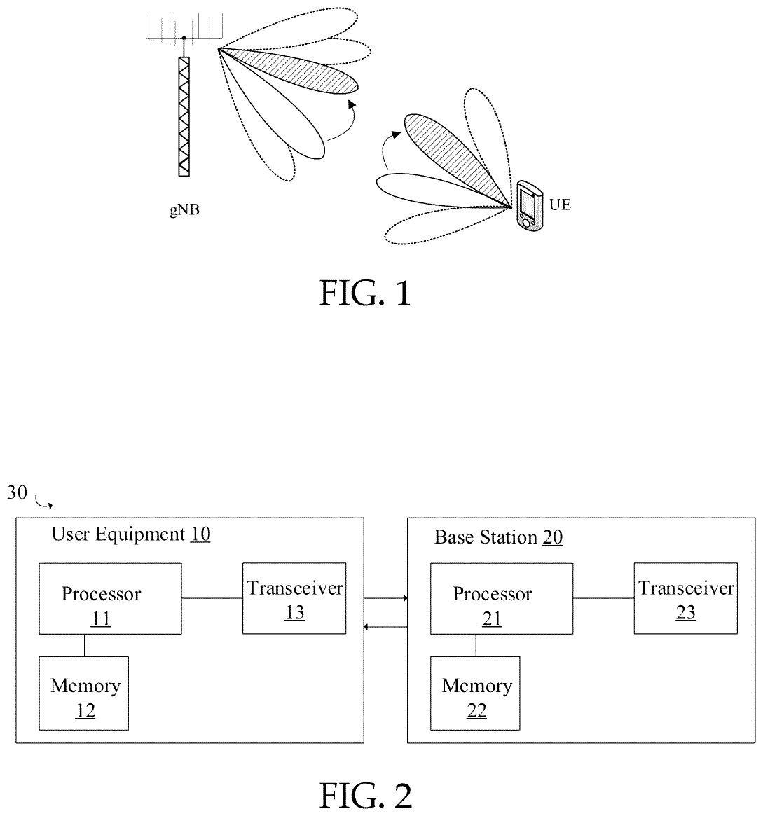

### DETAILED DESCRIPTION OF EMBODIMENTS

Embodiments of the disclosure are described in detail with the technical matters, structural features, achieved objects, and effects with reference to the accompanying drawings as follows. Specifically, the terminologies in the embodiments of the present application are merely for describeing the purpose of the certain embodiment, but not to limit the disclosure.

The following table includes some abbreviations, which may be used in some embodiments of the present application:

| Abbreviation | Full name |
|---|---|
| BWP | bandwidth part |
| CSI | channel-state information |
| DCI | downlink control information |
| MAC | medium access control |
| MAC CE | MAC control element |
| MIMO | multiple-input multiple-output |
| MPE | maximum permissible exposure |
| PDCCH | physical downlink control channel |
| PDSCH | physical downlink shared channel |
| PUCCH | physical uplink control channel |
| PUSCH | physical uplink shared channel |
| QCL | quasi co location |
| RRC | radio resource control |
| RS | reference signal |
| SRS | sounding reference signal |
| SRI | SRS resource indicator |
| SSB | synchronization signal block |
| TCI | transmission configuration indication |

In existing arts, TCI state for reception of each DL signal and spatial relation for transmission of each UL signal are configured by using different RRC signalling and are indicated/applied by different MAC CE and/or DCI. This results in a large amount of signalling overhead. In addition, beam restriction enhancement for simultaneous DL reception and UL transmission should be enhanced because of the limitation on ration frequency (RF) analog beam steering component, and it is difficult for UE to receive and transmit signals using different beams for different physical channels. Thus, it is beneficial to design a unified TCI framework for DL and UL beam indication.

The present application discloses the detail of whole solution of unified TCI framework in multi-beam transmission. In the unified TCI framework, joint DL/UL TCI state and separate DL/UL TCI state may share a common TCI state pool which can be configured by RRC signalling. The unified TCI state where SRS can be the source reference signal is proposed. The unified DL/UL MAC CE is proposed to active/de-active unified TCI state. The UL Transmission configuration indication field in UL DCI is proposed to indicate unified TCI state. In another aspect, unified path loss reference signal framework is proposed. In the unified path loss reference signal framework, a common path loss reference signal pool which can be configured by RRC signalling and MAC CE(s) used for path loss reference signal indication are proposed.

In more details, the application is related to a wireless communication system operating in a MIMO system. Unified TCI state framework is proposed for data and control transmission/reception for DL and UL in multi-beam transmission. The unified TCI state framework contains joint DL/UL TCI state and separate DL/UL TCI state. For joint DL/UL TCI state, a common TCI state pool is provided and UL TCI state is derived from DL TCI state. It is proposed a procedure how to active and indicate the TCI state for DL channels. For separate DL/UL TCI state, it is proposed to reuse the common TCI state pool and a procedure how to respectively active and indicate the TCI state for DL and UL channels. RRC signalling of unified TCI state, MAC CE used for unified TCI state activation/deactivation and UL Transmission configuration indication field in UL DCI are also proposed to support the unified TCI state framework. In another aspect, for the unified path loss reference signal framework, it is proposed a common path loss reference signal pool which can be configured by RRC signalling and MAC MAC CE to indicate path loss reference signal for PUCCH, PUSCH and SRS, respectively.

Beneficial effects of the invention of this application includes, but is not limited to, at least one of the followings. Introducing procedure of the joint DL/UL TCI state and the separate DL/UL TCI state leads to more flexible and uniform DL/UL beam indication. Unifying the source RSs of unified TCI into SSB, CSI-RS and SRS reduces the cost and latency of beam management. Introducing MAC CE(s) used for unified TCI activation/deactivation and UL Transmission configuration indication field in UL DCI leads to more flexible and uniform to utilize joint DL/UL TCI state and separate DL/UL TCI state. Introducing the common path loss reference signal pool for power control of UL channels and/or SRS reduces RRC signalling overhead.

FIG. 2 illustrates that, in some embodiments, one or more user equipments (UEs) 10 and a base station (e.g., gNB or eNB) 20 for wireless communication in a communication network system 30 according to an embodiment of the present application are provided. The communication network system 30 includes the one or more UEs 10 and the base station 20. The one or more UEs 10 may include a memory 12, a transceiver 13, and a processor 11 coupled to the memory 12 and the transceiver 13. The base station 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

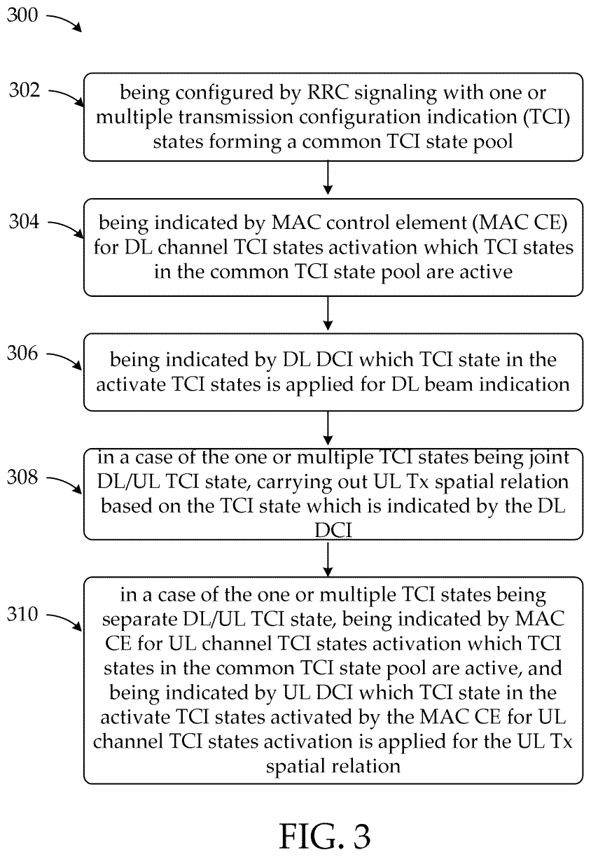

FIG. 3 illustrates a beam indication method 300 according to an embodiment of the present application. In some embodiments, the method 300 includes the followings. In block 302, the base station configured the UE or the UE is configured by the base station by RRC signalling with one or multiple transmission configuration indication (TCI) states forming a common TCI state pool. Then, in block 304, the UE is indicated by MAC control element (MAC CE) for DL channel TCI states activation which TCI states in the common TCI state pool are active. Next, in block 306, the UE is indicated by DL DCI which TCI state in the activate TCI states is applied for DL beam indication. In a case of the one or multiple TCI states being joint DL/UL TCI state, the base station and/or the UE carries out UL Tx spatial relation based on the TCI state which is indicated by the DL DCI (block 308). In a case of the one or multiple TCI states being separate DL/UL TCI state, the UE is indicated by the base station or the base station indicates to the UE by MAC CE for UL channel TCI states activation which TCI states in the common TCI state pool are active, and being indicated by UL DCI which TCI state in the activate TCI states activated by the MAC CE for UL channel TCI states activation is applied for the UL Tx spatial relation (block 310). This can solve issues in the prior art, reduce signalling overhead, enhance the unified TCI framework, and/or realize more flexible and uniform DL/UL beam indication.

More specifically, in existing arts, the signalling of DL beam indication and UL Tx spatial filter is TCI state and spatial relation, respectively. Also, each DL and UL channel has its own TCI state list and spatial relation list, respectively. For example, TCI state list for PDSCH and PDCCH is configured in higher parameters PDSCH-config and PDCCH-config, respectively. Similarly, spatial relation list for PUCCH and SRS is configured in higher parameters PUCCH-Spatial RelationInfo and SRS-Spatial RelationInfo, respectively. This current solution of TCI state/spatial relation framework of each channel/RS results in a large amount of RRC signalling overhead.

As a solution of unified TCI framework, in an embodiment of the present application, the unified TCI state framework contains joint DL/UL TCI state and separate DL/UL TCI state, which share a common TCI state pool. RRC signalling of unified TCI state, MAC CE used for unified TCI state activation/deactivation and DCI applied for DL beam indication support the unified TCI state framework.

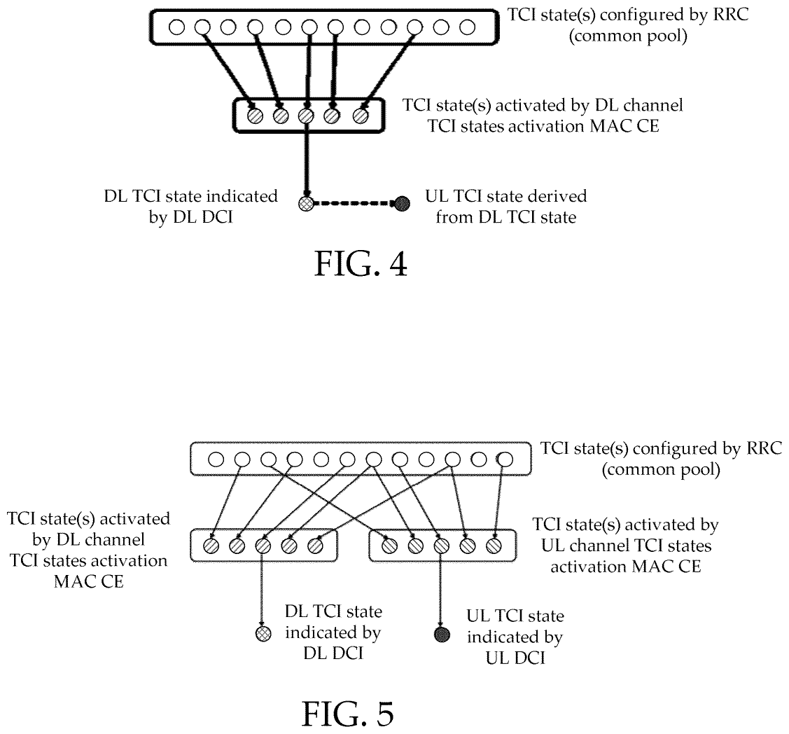

For joint DL/UL TCI state, one or multiple unified TCI state(s) are configured by RRC signalling. Note that the unified TCI state(s) form a common TCI state pool. Then DL channel TCI states activation MAC CE is used to indicate which TCI state(s) in the common TCI state pool is/are active for DL beam indication. DL DCI indicates which TCI state in the activate TCI states is applied for DL beam indication. UL Tx spatial filter is derived from the TCI state which is indicated by DL DCI. The procedure of joint DL/UL TCI state application is shown in FIG. 4.

For separate DL/UL TCI state, the common TCI state pool with one or multiple unified TCI state(s) can be reused. DL beam indication have the same procedure to the joint DL/UL TCI state. DL channel TCI states activation MAC CE and/or DL DCI are used to indicate which TCI state in the common TCI state pool is active/applied for DL beam indication. For UL Tx spatial relation, UL channel TCI states activation MAC CE is used to indicate which TCI state in the common TCI state pool is active for UL Tx spatial relation first. Then UL DCI indicates which TCI state in the activate TCI states is applied for UL Tx spatial relation. Note that the TCI state used for UL spatial Tx relation can be the same to or the different from that applied for DL beam indication. The procedure of separate DL/UL TCI state application is shown in FIG. 5.

Introducing procedure of the joint DL/UL TCI state and the separate DL/UL TCI state reduces signalling overhead and leads to more flexible and uniform DL/UL beam indication.

For RRC signalling of unified TCI state, in an embodiment of the present application, source RSs of the TCI state for the DL beam indication include sounding reference signal (SRS). In existing arts, for DL beam indication, SSB and CSI-RS are source RSs in TCI state, while for UL spatial Tx filter, SSB, CSI-RS and SRS are source RSs in spatial relation. Obviously, SRS cannot be applied to indicate DL beam for DL channels in existing arts. The reason may be that the number of SRS resources for beam management is much less than that of CSI-RS resources for beam management and the UE do not support beam correspondence (i.e., an ability of the UE to select a suitable beam for UL transmission based on DL measurements) in the use case of maximum permissible exposure (MPE). But from a different viewpoint, the less SRS resources can lead to much quicker UL beam training. It can reduce the latency of beam training and does not need DL beam management. Although the UE has MPE impact sometimes, for the beam correspondence situation without MPE impact, the UL measurement results cannot be used for TCI state indication when SRS resource set is applied to UL beam training. In the case of beam correspondence, the results of UL beam training are not fully utilized and thus lead to additional measurement. It is therefore proposed in an embodiment of the present application that SRS can be source RS in unified TCI state for DL beam indication. In the other words, the source RSs of unified TCI state are unified into SSB, CSI-RS and SRS. This solution can fully utilize the UL beam measurement and reduce the cost of beam management and latency of obtaining the optimal beam link. Table 1 shows an example of RRC signalling of unified TCI state. In Table 1, the parts marked by emphasis mark (i.e., bold italic font type), including SRS resource, are the proposed additions/modifications to the TCI-state information element in an embodiment of the present application.

TABLE 1
An example of RRC signalling of unified TCI state

| TCI-State ::= | SEQUENCE { | |
|---|---|---|
| tci-StateId | TCI-StateId, | |
| qcl-Type1 | QCL-Info, | |
| qcl-Type2 | QCL-Info | OPTINAL, |

...
}

| QCL-Info ::= | SEQUENCE { | |
|---|---|---|
| cell | ServCellIndex | OPTINAL, |
| bwp-Id | BWP-Id | OPTINAL, |

| | |
|---|---|
| referenceSignal | CHOICE { |
| csi-rs | NZP-CSI-RS-ResouceId, |
| ssb | SSB-Index, |
| srs | SEQUENCE { |
| resource | SRS-ResourceId, |
| uplinkBWP | BWP-Id |

```
    }
  }
```

| qcl-Type | ENUMERATED {typeA, typeB, typeC, typeD}, |
|---|---|
| ... | |
| } | |

For MAC CE(s) used for unified TCI state activation/deactivation, in an embodiment of the present application, the MAC CE includes a unified TCI state indication field for activating the TCI states in the common TCI state pool, and unified TCI state indication field is expanded. It is analyzed the number of bits of unified TCI state indication field in MAC CE. In existing arts, DL and UL channels have their own TCI state list and spatial relation list, respectively. For the UE-specified DL channels, the maximum quantity of TCI state list for PDSCH and PDCCH the UE can be configured with is 128 (determined by the higher parameter maxNrofTCI-States) and 64 (determined by the higher parameter maxNrofTCI-StatesPDCCH), respectively. For the UE-specified UL channels, the maximum quantity of spatial relation list for PUCCH the UE can be configured with is 64 (determined by the higher parameter maxNrof SpatialRelationInfos-r16). If there is not coincident among TCI state list for PDSCH and PDCCH and spatial relation list for PUCCH, the total number of TCI state list plus spatial relation list is 256. Therefore, the maximum quantity of the unified TCI state in the common TCI state pool would be possible to be larger than 128. In existing arts, the number of bits in MAC CE field which is used for activating/indicating TCI state/spatial relation is always equal to and less than 7. It is not enough to active/indicate unified TCI state in the common TCI state pool. Therefore, it is proposed in an embodiment of the present application that the number of bits of unified TCI state indication field in MAC CE should be larger than 7.

In an embodiment of the present application, for the joint DL/UL TCI state, it is possible that only one MAC CE is used for DL channel TCL state activation and UL TCI state/UL Tx spatial relation is derived from DL TCI state; for the separate DL/UL TCI state, the one MAC CE used for DL channel TCL state activation may be reused and another one MAC CE is needed for UL channel TCL state activation. In existing arts, different MAC CE is used for TCI state activation/deactivation for different channels. For PDCCH, TCI State Indication for UE-specific PDCCH MAC CE is used. For PDSCH, (enhanced) TCI States Activation/Deactivation for UE-specific PDSCH MAC CE is used. For PUCCH, (enhanced) PUCCH spatial relation activation/deactivation MAC CE is used. For PUSCH, the spatial relation is determined according to SRS resource indicator (SRI) field in DCI. This mechanism may cause a large amount of MAC CE signalling overhead and is hard to maintain DL/UL beam alignment. For joint DL/UL TCI state, only one MAC CE used for UE-specific DL channels to active/de-active DL TCI state is needed because UL TCI state can be derived from DL TCI state. For separate DL/UL TCI state, one MAC CE used for UE-specific DL channels can be reused to active/de-active DL TCI state and another one MAC CE is used for UE-specific UL channels to active/de-active UL TCI state. This design may reduce signalling and is easy to maintain beam alignment.

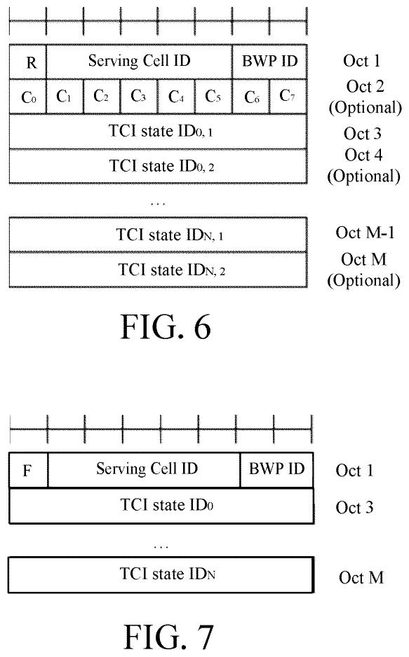

FIG. 6 shows an example of unified TCI states activation/deactivation for DL channels MAC CE. The Serving Cell ID field indicates the identity of the Serving Cell for which the MAC CE applies and its length is 5 bits. The BWP ID field indicates a DL BWP for which the MAC CE applies as the codepoint of the DCI bandwidth part indicator field as specified in TS 38.212 and its length is 2 bits. The Cᵢ field indicates whether the octet containing TCI state ID_{i,2} is present. If this field is set to a first value (e.g., “1”), the octet containing TCI state ID_{i,2} is present. If this field is set to a second value (e.g., “0”) or not present, the octet containing TCI state ID_{i,2} is not present. The TCI state ID_{i,j} field indicates one of the unified TCI states in the common TCI state pool, where i is the index of the codepoint of the DCI Transmission configuration indication field as specified in TS 38.212 and TCI state ID_{i,j} denotes the j^{th} TCI state indicated for the i^{th} codepoint in the DCI Transmission Configuration Indication field. The maximum number of activated TCI codepoint is 8 and the maximum number of TCI states mapped to a TCI codepoint is 2. The R filed is a reserved bit.

FIG. 7 shows an example of unified TCI states activation/deactivation for UL channels MAC CE. The Serving Cell ID field indicates the identity of the Serving Cell for which the MAC CE applies and its length is 5 bits. The BWP ID field indicates a UL BWP for which the MAC CE applies as the codepoint of the DCI bandwidth part indicator field as specified in TS 38.212 and its length is 2 bits. The F field indicates whether the octet containing TCI state IDᵢ (i=0,1, . . . ,N) is present. If this field is set to a first value (e.g., “1”), the octet containing TCI state IDᵢ is present. If this field is set to a second value (e.g., “0”), the octet containing TCI state ID is not present. The TCI state IDᵢ field indicates one of the unified TCI states in the common TCI state pool, where i is the index of the codepoint of the DCI UL Transmission configuration indication field as discussed below.

When the F field is set to the first value (e.g., “1”) and the TCI state IDᵢ field is present, the TCI state applied for UL Tx spatial filter is different from that applied for DL beam indication. In this case, the separate DL/UL TCI state is applied. When the F field is set to the second value (e.g., “0”) or TCI state IDᵢ field is not present, UL Tx spatial filter is derived from the TCI state applied for DL beam indication. In this case, the joint DL/UL TCI state is applied.

For UL Transmission configuration indication field in UL DCI, in an embodiment of the present application, the joint DL/UL TCI state is applied if this field contains 0 bit and the separate DL/UL TCI state is applied if this field contains at least one bit. For separate DL/UL TCI state, DL TCI state and UL TCI state need to be indicated by DL DCI and UL DCI, respectively. The Transmission configuration indication field in DL DCI in existing arts can be reused to indicate DL TCI state. But there is a field not like the Transmission configuration indication field in DL DCI. Therefore, a new field UL Transmission configuration indication should be introduced into UL DCI (e.g., DCI format 0_1 and/or 0_2). This field contains a maximum of 3 bits, for example. That is, up to 8 unified TCI states in the common TCI state pool are mapped to the codepoints of this field. When this field contains 0 bit, UL Tx spatial filter is derived from the unified TCI state applied for DL beam indication. In this case, the joint DL/UL TCI state is applied because the TCI state applied for UL Tx spatial filter is associated with that applied for DL beam indication. When this field contains 1 or 2 or 3 bits for example, this field indicates which TCI state activated by MAC CE is applied for UL Tx spatial relation. In this case, the separate DL/UL TCI state is applied because the TCI state applied for UL Tx spatial filter is independent on that applied for DL beam indication.

Introducing MAC CE(s) used for unified TCI activation/deactivation and UL Transmission configuration indication field in UL DCI leads to more flexible and uniform to utilize joint DL/UL TCI state and separate DL/UL TCI state.

Path loss reference signal is associated with one or more types of uplink transmission. For example, the BS may transmit a plurality of different path loss reference signals on PUCCH, PUSCH, and SRS to estimate path loss on respective uplink channel between the UE and the BS for UE uplink power control. In existing arts, each UL channel has its own path loss reference signal list. For example, path loss reference signal list for PUCCH, PUSCH and SRS is configured in higher parameter PUCCH-Pathloss ReferenceRS, PUSCH-PathlossReferenceRS and PathlossReferenceRSList, respectively. This existing solution of path loss reference signal framework of each UL channel results in RRC signalling overhead. Especially, the path loss reference signal applied for PUCCH power control is indicated by spatial relation applied for PUCCH. While unified TCI state is independent with path loss reference signal, it is necessary to introduce a unified path loss reference signal framework.

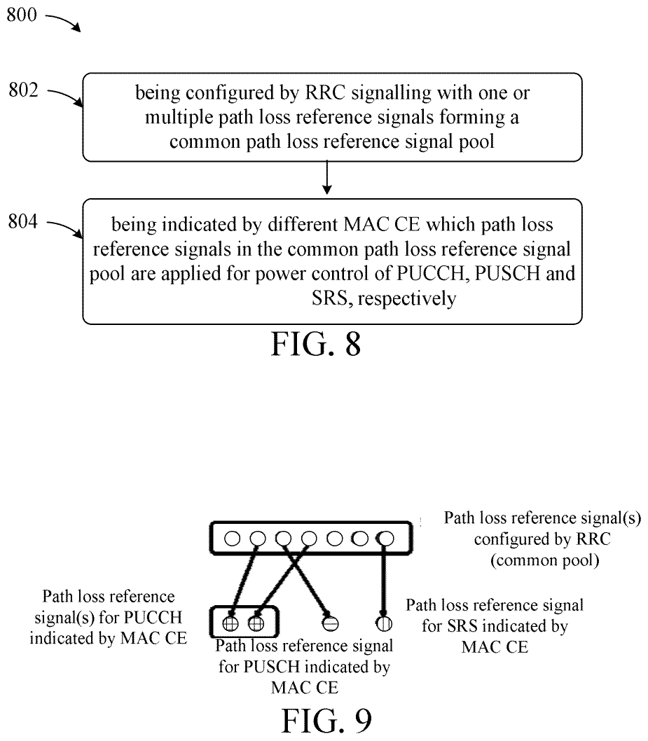

FIG. 8 is a flowchart of a path loss reference signal indication method 800 according to an embodiment of the present application. In an embodiment of the present application, referring to FIG. 8, to realize the unified path loss reference signal framework, the base station may configure the UE or the UE may be configured by the base station by RRC signalling with a common pool (that is, a common path loss reference signal pool) which consists of path loss reference signals (block 802), and the UE is indicated by different MAC CE which path loss reference signals in the common pool are applied for power control of PUCCH, PUSCH and SRS, respectively (block 804). As shown in FIG. 9, the framework of unified path loss reference signal application is provided. A common pool which consists of unified path loss reference signal(s) can be configured by RRC signalling. Path loss reference signal(s) applied for power control of PUCCH, PUSCH and SRS are indicated by different MAC CE, respectively. Respective MAC CE design implies that each UL channel can control power dependently. Table 2 shows an example of RRC signalling of unified path loss reference signal in the common pool.

TABLE 2
An example of RRC signalling of unified path loss reference signal

| | |
|---|---|
| PathlossReferenceRS ::= | SEQUENCE { |
| pathlossReferenceRS-Id | PathlossReferenceRS-Id |
| referenceSignal | CHOICE { |
| ssb-Index | SSB-Index, |
| csi-RS-Index | CSI-RS-ResourceId, |

}
}

For MAC CE(s) used for path loss reference signal indication, in an embodiment of the present application, the MAC CE includes a unified path loss reference signal indication field for activating or indicating the path loss reference signals in the common pool, and the unified path loss reference signal indication field is expanded. In existing arts, the maximum quantity of path loss reference signal list for PUCCH, PUSCH and SRS the UE can be configured with is 64 (determined by the higher parameter max NrofPUCCH-PathlossReferenceRSs-r16, max NrofPUSCH-PathlossReferenceRSs-r16 and max NrofSRS-PathlossReferenceRSs-r16, respectively). If there is not coincident among path loss reference signal list for PDCCH, PDSCH and SRS, the total number of path loss reference signal list is 192. Therefore, the maximum quantity of path loss reference signal list in the common path loss reference signal pool would be larger than 64. In existing arts, the number of bits in MAC CE field which is used for activing/indicating path loss reference signal is always equal to 6. It is not enough to active/indicate path loss reference signal in the common path loss reference signal pool. Therefore, the unified path loss reference signal indication field in MAC CE in existing arts needs to be expanded. It is proposed in an embodiment of the present application that the MAC CE includes a unified path loss reference signal indication field for activating or indicating the path loss reference signals in the common pool, and the number of bits of the unified path loss reference signal indication field in the MAC CE is larger than 6. Meanwhile, a new MAC CE used for unified path loss reference signal indication for PUCCH should be introduced.

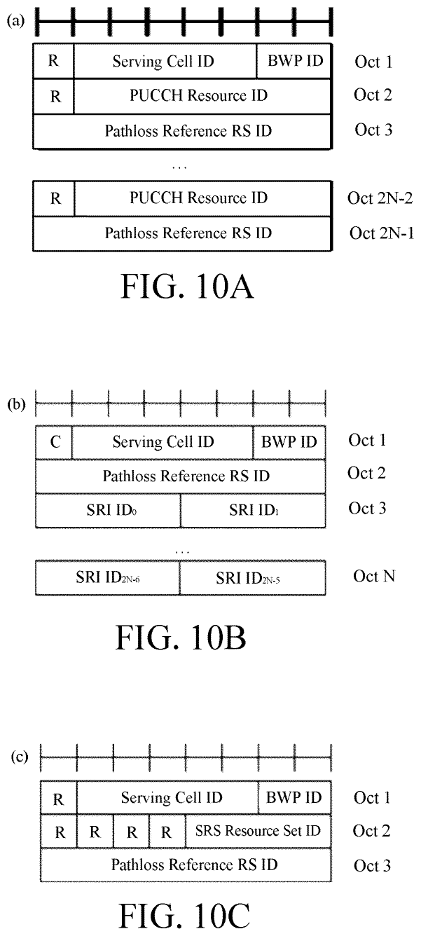

In an embodiment of the present application, MAC CE used for unified path loss reference signal indication includes a field indicating the path loss reference signal in the common pool. FIGS. 10A, 10B and 10C shows examples of MAC CE used for unified path loss reference signal indication for PUCCH, PUSCH and SRS, respectively. The Serving Cell ID field indicates the identity of the Serving Cell for which the MAC CE applies and its length is 5 bits. The BWP ID field indicates a UL BWP for which the MAC CE applies as the codepoint of the DCI bandwidth part indicator field as specified in TS 38.212 and its length is 2 bits. The Pathloss Reference RS ID field indicates the unified path loss reference signal in the common pool.

Introducing the common path loss reference signal pool for power control of UL channels and/or SRS reduces RRC signalling overhead.

Commercial interests for some embodiments are as follows. 1. Solving issues in the prior art. 2. Reducing signalling overhead. 3. Reducing the cost and latency of beam management. 4. leading to more flexible and uniform to utilize joint DL/UL TCI state and separate DL/UL TCI state. 5. Providing a good communication performance. 6. Providing a high reliability. Some embodiments of the present application are used by 5G-NR chipset vendors, V2X communication system development vendors, automakers including cars, trains, trucks, buses, bicycles, moto-bikes, helmets, and etc., drones (unmanned aerial vehicles), smartphone makers, communication devices for public safety use, AR/VR device maker for example gaming, conference/seminar, education purposes. Some embodiments of the present application are a combination of “techniques/processes” that can be adopted in 3GPP specification to create an end product. Some embodiments of the present application could be adopted in the 5G NR unlicensed band communications. Some embodiments of the present application propose technical mechanisms.

While the present application has been described in connection with what is considered the most practical and preferred embodiments, it is understood that the present application is not limited to the disclosed embodiments but is intended to cover various arrangements made without departing from the scope of the broadest interpretation of the appended claims.

1. A user equipment (UE), comprising a processor, configured to call and run program instructions stored in a memory, to execute:
being configured by radio resource control (RRC) signalling with one or multiple transmission configuration indication (TCI) states forming a common TCI state pool;
being indicated by medium access control (MAC) control element (CE) for downlink (DL) channel TCI states activation which TCI states in the common TCI state pool are active;
in a case of the one or multiple TCI states being joint DL/uplink (UL) TCI state, being indicated by DL DCI which TCI state in the activate TCI states is applied for DL beam indication, and UL Tx spatial filter is derived from the TCI state which is indicated by DL DCI.

2. (canceled)

3. The UE accordinig to claim 1, wherein the MAC CE comprises an unified TCI state indication field for activating the TCI states in the common TCI state pool.

4. The UE accordinig to claim 1, wherein for the joint DL/UL TCI state, only one MAC CE is used for DL channels to indicate which TCI states in the common TCI state pool are active.

5. The UE accordinig to claim 1, wherein the MAC CE for DL channel TCI states activation comprises a field indicating whether an octet containing TCI state ID of the TCI state in the common TCI state pool is present, and wherein If the field is set to a first value, the octet containing the TCI state ID is present; and if the field is set to a second value or not present, the octet containing the TCI state ID is not present.

6-7. (canceled)

8. A base station (BS), comprising a processor, configured to call and run program instructions stored in a memory, to execute:
configuring a user equipment (UE) by radio resource control (RRC) signalling with one or multiple transmission configuration indication (TCI) states forming a common TCI state pool;
indicating to the UE by medium access control (MAC) control element (CE) for downlink (DL) channel TCI states activation which TCI states in the common TCI state pool are active;
indicating to the UE by DL downlink control information (DCI) which TCI state in the activate TCI states is applied for DL beam indication;
in a case of the one or multiple TCI states being joint DL/uplink (UL) TCI state, carrying out UL Tx spatial relation based on the TCI state which is indicated by the DL DCI; and
in a case of the one or multiple TCI states being separate DL/UL TCI state, indicating to the UE by MAC CE for UL channel TCI states activation which TCI states in the common TCI state pool are active, and indicating to the UE by UL DCI which TCI state in the activate TCI states activated by the MAC CE for UL channel TCI states activation is applied for the UL Tx spatial relation.

9. (canceled)

10. The BS accordinig to claim 8, wherein the MAC CE comprises an unified TCI state indication field for activating the TCI states in the common TCI state pool.

11. The BS accordinig to claim 8, wherein for the joint DL/UL TCI state, only one MAC CE is used for DL channels to indicate which TCI states in the common TCI state pool are active.

12. The BS accordinig to claim 8, wherein the MAC CE for DL channel TCI states activation comprises a field indicating whether an octet containing TCI state ID of the TCI state in the common TCI state pool is present, and wherein If the field is set to a first value, the octet containing the TCI state ID is present; and if the field is set to a second value or not present, the octet containing the TCI state ID is not present.

13-28. (canceled)

29. A user equipment (UE), comprising a processor, configured to call and run program instructions stored in a memory, to execute:
being configured by RRC signalling with one or multiple path loss reference signals forming a common path loss reference signal pool, wherein each path loss reference signal has an ID and is associated with a downlink refenrece signal.

30. The UE accordinig to claim 29, wherein the MAC CE comprises a unified path loss reference signal indication field for activating or indicating the path loss reference signals.

31. The UE according to claim 29, wherein the MAC CE comprises a Pathloss Reference RS ID field indicating the path loss reference signal.

32-43. (canceled)

44. The UE according to claim 29, wherein the processor is further configued to execute being indicated by different medium access control (MAC) control element (CE) which path loss reference signals are applied for power control of different uplink channels/signals.
